(19) United States
(12) Patent Application Publication
(10) Pub. No.: US 2008/0010151 A1
(43) Pub. Date: Jan. 10, 2008

(54) Consumer loyalty system and method with centralized processing

(76) Inventors: Thomas L. Bridges, Melbourne Beach, FL (US); Anthony P. Galluscio, Indialantic, FL (US); David A. Boley, Melbourne Beach, FL (US)

Correspondence Address: HAYWORTH, CHANEY & THOMAS, P.A., 202 N. HARBOR CITY BLVD., SUITE 300, MELBOURNE, FL, 32935, US

(21) Appl. No.: 11/606,530

(22) Filed: Nov. 30, 2006

Related U.S. Application Data
(63) Continuation-in-part of application No. 11/454,270, filed on Jun. 16, 2006.

(51) Int. Cl. G06Q 30/00

(52) U.S. Cl. 705/14

(57) ABSTRACT

The present invention is a method and a system for storing and communicating information between a consumer and proprietor, enabling the proprietor to build a database of consumer information and enabling the consumer to build a database of information from businesses participating in the system of the present invention. The invention enables the proprietor to analyze consumer habits and communicate incentives and rewards to specific consumers. Consumers utilize a handheld personal information device to store a unique personal identifier. The personal information device transmits the unique personal identifier to, and may receive information from, an information exchange unit upon entry of the consumer into a participating place of business. Consumer personal information and transaction data are recorded and stored in a secure central database. The business proprietor establishes reward criteria specific to his business to reward consumer loyalty and may analyze consumer shopping habits, demographic information, and geographic information.

### CROSS REFERENCE TO RELATED APPLICATIONS

This application is a continuation in part of application Ser. No. 11/454,270 filed in the UPSTO on Jun. 16, 2006, which is specifically incorporated by reference in its entirety as if fully set forth herein.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISK

Not Applicable.

### BACKGROUND OF THE INVENTION

1. Field of the Invention

The invention relates to the field of products and systems intended for use in aiding merchants in collecting and organizing consumer information, and utilizing such information to increase consumer loyalty and reward frequent procurement of the merchant's goods or services or frequent visitation to the merchant's place of business. Such loyalty programs improve business-consumer relationships and enhance the merchant's profitability. Examples of such loyalty programs include individualized identification cards with bar codes or magnetic stripes containing consumer identification information which are utilized by Point Of Sale (POS) systems in grocery stores, and frequent flyer programs utilized by airlines to track the number of miles flown by a particular consumer. Rewards can be awarded based upon frequency of use, number of miles flown, amount of purchases made within a given time, or other metrics as determined by the merchant.

2. Background Art

Proprietors of businesses have long sought to understand basic market information relating to particular consumers who are most likely to make use of the proprietor's business. Examples of the kind of consumer information typically sought include geographical location, age, gender, income level, shopping habits, eating habits, frequency of use of the proprietor's business products or services, amount of purchases made at the proprietor's place of business, frequency of use of proprietor's business products or services as a function of days of the week or months of the year, and the like. Such information can be extremely valuable to the proprietor as the proprietor seeks to analyze the market for the purpose of spending marketing and advertising funds more wisely, and for the purpose of making other business decisions such as where and when to open additional places of business, where and how to market his business, and so on. Furthermore, the business proprietor often utilizes such market information to reward consumers who frequent his place of business, who make large purchases, or who consistently bring other consumers to the place of business. Such rewards programs are commonly known as consumer loyalty programs.

One of the oldest known techniques for gathering this information is a simple jar placed in full view at the proprietor's place of business, sometimes simply called the “fish bowl”, in which consumers simply drop their business card or other identifying paper. This technique is cumbersome and is not readily adaptable for use in connection with a number of proprietor places of business, nor is it readily adaptable for use utilizing electronic data bases for data reduction and analysis utilizing software techniques. The fish bowl techniques are also non-secure in that any information dropped into the jar is easily stolen by other consumers, un-loyal employees, and the like.

Other consumer loyalty systems have been conceived which utilize Point Of Sale (POS) devices to capture consumer information. These systems collect information when the consumer makes a purchase at a merchant's place of business by utilizing a special magnetic or bar-coded card which is swiped or read at the time of purchase. Information from the card is then processed to allow the merchant to observe various metrics associated with a particular consumer. These metrics include the amount of purchases made by the consumer, the home address of the consumer, and the number of times a particular consumer visits the place of business. These consumer loyalty systems suffer from the drawback that the information is not collected until the consumer actually makes a purchase at the POS. Accordingly, consumers who enter a merchant's place of business without actually completing a purchase are not recorded by the consumer loyalty system. Another drawback to these systems is the lack of security and protection regarding consumer personal information. Still yet another drawback to these systems is that they are not easily adapted to some types of businesses such as restaurants, in which the consumer may not actually approach a register, but may instead pay at the table. In the restaurant application, the POS is often the consumer's dinner table, which does not easily lend itself for use in collecting such information.

Other consumer loyalty systems have been conceived for use in internet-based transactions. In these systems, a consumer typically places an order utilizing the World Wide Web, typically completing the transaction utilizing a credit card. The consumer enters personal information directly by keying it into spaces provided on the merchant's internet web site utilizing a personal computer, and this information is stored and analyzed to allow a merchant to reward consumer loyalty. These systems are not usable for business in which the transactions occur at a physical address, such as a restaurant, store, theatre, or the like.

It is therefore an object of the present invention to overcome the aforementioned shortcomings by providing a consumer loyalty system that is simple to use, optimally operates at or near the entry point of the merchant's place of business and performs an exchange of data with a minimum of consumer interaction, is secure regarding the consumer's personal information, does not require equipment to be placed at a particular POS within the proprietor's place of business, and is capable of recording consumer visits even if no purchase is made.

Customer loyalty systems have been disclosed that utilize a POS interface. U.S. patent application serial number US2004/0088221 A1, filed Jan. 3, 2002 by Katz et al., discloses a POS system that collects customer information and shares this information with a marketing company computer which processes the information in conjunction with a marketing data base. Customer data is compared to a data company data base for the purpose of identifying a particular customer with a block of other customers such that the amount of customer data to be analyzed is reduced and therefore manageable.

Another POS system is disclosed in U.S. Pat. No. 5,566,327, issued Oct. 15, 1996 to Sehr. This U.S. patent discloses a magnetic card or smart card based system for use by theme parks in which a customer is issued in magnetic or smart card coded with his personal information. When the card is presented at various points of sale within the theme park, personal information is recorded along with purchase information, such that a database can be constructed to analyze various aspects of customer behavior and to control customer rewards.

Consumer loyalty programs based solely on a POS system have the distinct drawback that a consumer must actually make a purchase before any information is recorded. No information is recorded when a consumer simply enters a store to perform what is commonly known as “window shopping”, in which the consumer simply views the merchant's display without making a purchase. In these instances, it is desirable that a merchant know that the consumer has at least made a visit to the store, as each visit represents a potential sale. It is therefore desirable that all consumer visits to a particular place of business be recorded and rewarded.

Other consumer loyalty programs have been devised. The airline industry has long utilized frequent flyer reward programs that reward consumers based upon the total number of miles flown, or the number of legs flown. These systems do not utilize a specific hardware interface; rather, they are information based systems in which the information used is input into computers by hand.

The loyalty systems of the prior art are generally employed by a single store or single chain of merchants, and therefore they are not configurable and usable by a plurality of small to medium sized local businesses or business chains. These local merchants are faced with the disadvantages related to limited staff, assets, and resources to develop their own loyalty and reward system due to the complexity and size of the effort required to develop and maintain such systems.

Some reward systems are paper-based and rely upon coupons or other papers transmitted to the consumer by mail, or transmitted by e-mail and then printed on a consumer's personal computer. These systems rely on the generation and retention of paper and are therefore susceptible to loss or theft. They are also inconvenient, slow, result in clutter, and are therefore ungainly.

There is therefore a need for a consumer information gathering and loyalty system which does not depend upon the making of a purchase by a consumer, such as the POS systems described above, for that consumer to participate in a reward/incentive system. Furthermore, there exists a need for a consumer loyalty system that is usable among a plurality of business entities and types, especially those businesses that are small to medium sized businesses, and there exists a further need for a consumer loyalty system that is individually configurable by each merchant or business proprietor who participates in the system. A need also exists for a merchant-configurable system which is simple, easy to use, provides rewards and incentives to the consumer, is available for use and able to be tailored to the individual needs of the small to medium sized business, and is based upon reliable technology. A need also exists for a paperless and reliable system for delivery of consumer rewards/incentives. Based upon the aspects and features of the invention, the advantages of this invention will include allowing consumer participation in the present rewards/incentive system without purchases being a necessary at a place of business, allowing use of the present inventive reward/incentive system by a plurality of business proprietors, providing each business proprietor with uniquely customizable criteria and options for their respective rewards/incentive programs, protecting personal consumer information on a centralized database, and providing a reliable paperless delivery system for earned consumer rewards/incentives.

All patents and printed patent publications referenced in this application are specifically incorporated by reference in their entirety, as if they were fully set forth herein.

As used in this application, “customer” and “consumer” are used interchangeably to identify a person who visits a retail establishment such as a store, restaurant, or the like. “Place of business” is used to identify a retail establishment. “Business proprietor” is used to identify the owner of the retail establishment, or his agent. “The system” is used to identify the system of the invention as further defined in this application. The consumer is anticipated in most cases to possess a personal computer, referred to as “consumer's personal computer” or simply a “personal computer” which is comprised at least of a memory, a connection with the World Wide Web by any of the means commonly known for such connection, email software well known in the art, web browsing software well known in the art, a keyboard and monitor, and which may have one or more of the following: an infrared communication interface, a serial communication interface, a serial Universal Serial Bus (USB) interface, a radio interface such as Bluetooth™, and software necessary for synchronizing with a Personal Digital Assistant, or PDA. “Personal Digital Assistant”, or PDA, is a device well known in the art and includes cell phones with PDA capability, which may include but is not limited to the ability to store and communication information via techniques well known in the art including but not limited to radio frequency communication means such as Bluetooth™ and infrared communication means. “Participating business” is a business that utilizes the system of the invention to reward consumer loyalty. “Unique personal identifier” is an alphanumeric character set which assigned to one and only one consumer, and which is never re-used. The unique personal identifier uniquely identifies a specific consumer. Consumer transactions at a participating place of business can occur in two separate forms. A “purchase transaction” originates at the POS when the consumer is making a purchase at the place of business. A “visit transaction” occurs when a consumer enters a place of business and interfaces their Personal Information Device (PID) with the business' Information Exchange Unit (IEU), without a consumer purchase being required.

### BRIEF SUMMARY OF THE INVENTION

The consumer information and reward system of the present invention overcomes the aforementioned shortcomings of the systems of the prior art by providing a merchant-configurable system that can be tailored to provide a specific reward or incentive program envisioned by a business proprietor, and is especially beneficial to small to medium sized business operations because it is simple to use, easy to maintain, and requires very little development on the part of the business proprietor. The scope of the present invention includes a method and a system comprised of constituent elements, described below, that enables businesses and consumers to exchange information, and furthermore enables the business proprietor to analyze consumer data, send business information to all of the business' consumer population registered on the system, establish an automatically occurring rewards program that is triggered upon fulfillment of a first level of criteria determined by the proprietor, and generate incentives for a subset of consumers fulfilling a second level of criteria determined by the business proprietor. Each individual business proprietor using the present invention may uniquely configure their respective criteria levels for their reward program and incentive program, respectively, based upon metrics specifically tailored to their business. Consumers may collect business information (address, phone, hours of operation, menu, etc.) from businesses they visit and receive rewards/incentives from the businesses for their patronage. The ability to collect and analyze consumer information enables business proprietors to tailor business operations to better fit the needs and habits of consumers and to provide rewards and incentives to consumers based upon metrics determined by the business proprietor. For instance, the system of the present invention enables the business proprietor to offer rewards to loyal consumers based upon the number of visits to their place of business (i.e. a number-of-visits reward program), the number of purchases made at their place of business (i.e. a number-of-purchases reward program), the consumer's purchase volume at their place of business (i.e. a purchase-volume reward program), or the like. Providing business information to the consumer enables the consumer to retain contact, sales, offers, rewards, incentives and other business-specific information, which tends to aid in the building of a relationship between the consumer and the business. The system is simple, paperless, easy to use, and utilizes standard interfaces well known in the art, including the World Wide Web, to communicate between the subsystems of the present invention and the consumer.

The invention is comprised of the following components: at least one Business Subsystem having an Information Exchange Unit (IEU) and a business server; a Central Subsystem having a central database, a database service application, a business web application, a consumer web application, and a Personal Information Device (PID) support application; and at least one PID. The consumer may, or may not, possess a personal computer as is discussed further in this description. The invention may be comprised of any number of Business Subsystems without limitation. The Business Subsystem provides consumer identification and transaction records to the Central Subsystem, whereupon the Central Subsystem stores transaction information on the central database. The consumer may access his personal information and reward/incentive status information, as well as lists and contact information of participating businesses, by communicating with the consumer web application of the Central Subsystem via the World Wide Web utilizing a personal computer. A business proprietor may access information relative to his consumers, generate his specific informational, reward and incentive programs, and review his consumer transaction data and consumer progress towards such rewards and incentive programs by communicating with the business web application of the Central Subsystem.

The Central Subsystem resides on one or more hardware servers in communication with the World Wide Web, and the consumer and the business proprietor communicate with the Central Subsystem via the World Wide Web. The Central Subsystem enables the consumer to view and update his own personal information stored on the Central Subsystem's central database, and to view a listing of the businesses in a given geographical region that are participating businesses of the present inventive system. This feature of the invention enables the consumer to select a specific business prior to making a business transaction, so that the consumer may choose to do business with business proprietors who are also participating businesses of the present invention. In this manner, the system provides a benefit to the business proprietor in that consumers may be driven to his business because the consumer understands that he will receive a personal benefit through the consumer loyalty program of the present invention. The information stored on the Central Subsystem's central database may be, and preferably is, protected by a firewall to provide a measure of security to the consumer and business proprietor. Data protected by such a firewall only allows specific types of access (via ports) by specific people (having valid login and password information) at specific locations (i.e. an ip address). The information stored on the Central Subsystem's central database may be further protected by encryption techniques well known within the computer arts. The Central Subsystem enables business proprietors to view and analyze consumer information, shopping habits, shopping trends, times and dates of visits to their place of business, amount spent over a given period of time, and other information by communicating with the Central Subsystem's central database via a World Wide Web connection to the Central Subsystem's business web application.

The method for rewarding consumer loyalty according to the system and method of the present invention is as follows: providing a central subsystem in communication with the World Wide Web, the central subsystem comprising a central database; providing at least one business subsystem in communication with the World Wide Web; storing business information desired to be presented to the consumer, consumer reward criteria and consumer incentive criteria on the central database; providing to the consumers at least one personal information device communicable with the business subsystem by a first communication means, each of the at least one personal information devices storing a unique personal identifier; presenting the at least one personal information device at a place of business for logging a consumer transaction in the business subsystem; communicating the unique personal identifier and transaction data from the business subsystem to the central database of the central subsystem; analyzing the consumer transaction data stored on the central database to produce a listing containing the identification of consumers meeting the reward criteria and the incentive criteria; and communicating the list of consumers meeting the reward criteria and the incentive criteria to the business subsystem.

In greater detail, the method steps involved in the present invention may entail: first, a business proprietor becomes a participating member/business of the system of the invention by utilizing the business web application of the Central Subsystem and/or may contact the support staff of the present invention to enter business information and establish reward/incentive criteria into the Central System's central database during the registration process. A consumer then registers with the system as defined in this description, and a unique personal identifier is assigned specifically to that consumer. During this registration process a consumer's personal information is entered into and stored on the Central Subsystem central database and is linked to the consumer's unique personal identifier. The consumer's unique personal identifier may be provided by a pre-printed card given to the consumer, or it may be loaded onto a Personal Information Device (PID) in accordance with the description of the present invention herein. Next, the consumer visits a participating business and presents his PID to the IEU of the Business Subsystem to log a visit transaction at the place of business. The Business Subsystem communicates the consumer's unique personal identifier and any transaction information for that visit to the business web application of the Central Subsystem, whereupon the consumer's transaction information is stored on the central database of the Central Subsystem. The consumer may also present their PID at the POS while making a purchase at the place of business, thus logging a purchase transaction, and similar to above, the consumer's unique personal identifier and any transaction information for the purchase transaction is communicated to and stored on the central database of the Central Subsystem. After the consumer has fulfilled the specific criteria pertaining to visit transactions or purchase transactions required to meet the business proprietor's reward/incentive system, the Central Subsystem communicates the reward or incentive to the Business Server. The consumer is then notified via the consumer web application of the Central Subsystem that he has reached a reward or incentive level and that a reward or incentive is waiting for him at the particular place of business. Upon the consumer's next visit to that particular place of business and identification of the consumer by presentation of the consumer's PID while making a purchase transaction at that place of business, the reward or incentive is provided. Exemplary rewards or incentives may include, but are not limited to, free merchandise or discounts off purchases made by the consumer. At any time the consumer may communicate with the consumer web application of the Central Subsystem from any personal computer in order to gain an understanding of his progress towards rewards or incentives for any given participating business. A business proprietor may communicate with the business web application of the Central Subsystem to gain understanding of consumer data such as demographic data, geographic data, frequency of visits, types of items purchased, amount of purchases made, and so forth for individual consumers and groups of consumers.

A first aspect of the invention is that the Information Exchange Unit (IEU) of the Business Subsystem is portable and thus can be placed at a physical location within a participating business such that it interfaces with the PID of a consumer at the point most convenient to do so. This aspect overcomes the disadvantage of strictly point of sale (POS) consumer loyalty systems that must be physically located near the POS, for instance at the cash register of a restaurant.

A second aspect of the invention is that visit transactions utilizing the IEU of the present invention may be done at any time during the consumer's visit to the proprietor's place of business. It is not necessary that the invention be used only at the time a consumer completes a purchase transaction, as is required in POS consumer loyalty systems within the art. This overcomes the disadvantage of POS loyalty systems that require an actual sales transaction in order to achieve collection of data from the consumer. The present invention enables business proprietors to monitor and subsequently provide rewards and/or incentives when consumers attain or exceed configurable visit transaction and/or purchase transaction criteria.

A third aspect of the invention is that it comprises readily available industry standard data interfaces including but not limited to serial bus interfaces such as the Universal Serial Bus (USB), magnetic card reader interfaces, Personal Digital Assistant (PDA) infrared interfaces, radio frequency communication interfaces such as the industry standard known as Bluetooth™, optical bar code interfaces, and radio frequency tag interfaces; and furthermore it utilizes standard techniques for communicating via the World Wide Web.

A fourth aspect of the present invention is that the reward/incentive achieved by the consumer may be electronically stored and may be automatically applied to the consumer's bill or account at the time of award achievement, reducing the need for any printed coupons or the transmission thereof.

A fifth aspect of the invention is that the Personal Information Device (PID) is small enough to be handheld so that it can easily be carried by the consumer.

A sixth aspect of the invention is that each business proprietor participating in the system is enabled to initially structure a consumer loyalty and rewards program based upon criteria specific to the proprietor's business operation during the business' registration with the system, and each business proprietor is thereafter enabled to provide a customizable consumer incentive program based upon on consumer information stored on the Central Subsystem central database. Thus, the system provides a significant advantage over consumer loyalty systems of the prior art because it is configurable and tailorable to the needs of the individual business proprietor.

A seventh aspect of the system is that a participating business is enabled to provide business-specific information to the consumers, and thus build and enhance their consumer-business relationships. These enhanced consumer-business relationships are beneficial to the business proprietor in that consumers who are provided information specific to a business may be more likely to return to the business, resulting in increased traffic and sales. The business information provided to the consumer may include but is not limited to contact information, such as telephone number, address information, email address, fax number, and the like; sales and promotional information, such as sales dates and special pricing; consumer reward information that is provided to the consumer based upon a specific consumer's metrics which include but are not limited to frequency of visits, amount of purchase, and the like; and other information determined by the business proprietor to be important in building and enhancing consumer-business relationships.

### BRIEF DESCRIPTION OF THE SEVERAL VIEWS OF THE DRAWINGS

FIG. 1 depicts a basic system block diagram of the present invention.

FIG. 2 depicts a block diagram of elements within the Central Subsystem of the present invention.

FIG. 3 depicts a block diagram of elements within the Business Subsystem(s) of the present invention.

FIG. 4 depicts a flow diagram of the interactions between components of the Business Subsystem of the present invention.

FIG. 5 depicts a flow diagram of the interactions between components of the Business Subsystem with a Personal Information Device (PID) of the present invention.

FIG. 6 depicts a PDA embodiment of the PID of the present invention.

FIG. 7 depicts a USB thumb drive embodiment of the Personal Information Device (PID) of the present invention.

FIG. 8 depicts a flow diagram of the interactions between Business Subsystem(s) and the Central Subsystem of the present invention.

### DETAILED DESCRIPTION OF THE INVENTION

The invention is directed to a centralized consumer loyalty system, herein referred to as “the system”, including a method and system for exchanging consumer personal information with a business proprietor during both a consumer's non-purchasing visit transactions and purchase transactions at the proprietor's place of business, allowing the proprietor to analyze consumer shopping and spending habits, perform general demographic analyses, reward consumer loyalty, provide purchase incentives to subsets of consumers and perform other analyses beneficial to the business proprietor for the purpose of tailoring business activities to effectively address and reward the proprietor's specific market. The consumer receives information about the business at a level determined by the business proprietor (for example, address, phone, web address, email, menu, and hours of operation). The system of the invention is applicable to any business establishment including but not limited to retail stores, restaurants, wholesale establishments, theme parks, theatres, sports stadiums, service providers, and any other business establishment which serves consumers by providing goods, services, or entertainment.

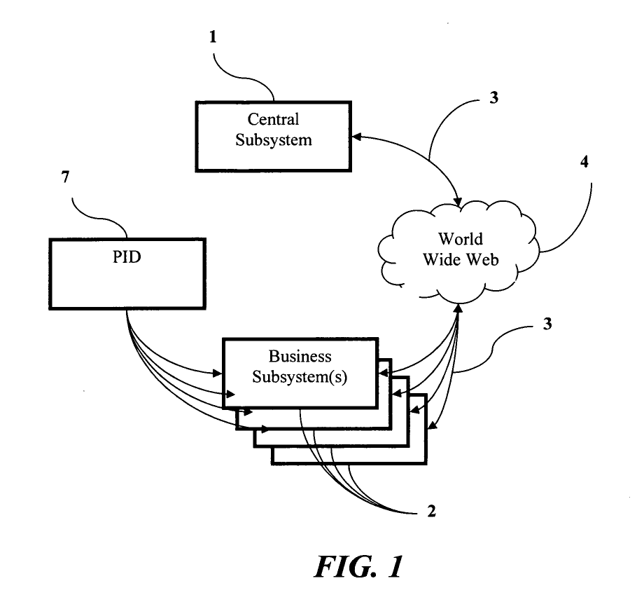

Referring to FIG. 1, the invention is comprised of at least one each of two subsystems: a Business Subsystem 2 and a Central Subsystem 1; a communication means 3; the World Wide Web 4; and at least one Personal Information Device (PID) 7. Preferably, the system is comprised of a plurality of Business Subsystems which may be unlimited in number and which are in communication with the Central Subsystem 1 via communication means 3 and the World Wide Web 4. Communication means 3 is a connection to the World Wide Web, of which there are many varieties well known in the art. Such connections to the World Wide Web include, but are not limited to, DSL, ADSL, cable modem, dial-up telephone, wireless communications utilizing industry standards such as Wi-Fi, and the like. The system of the invention is not limited by the type of connection to the World Wide Web that comprises communication means 3. Furthermore, communication means 3 may be comprised of a combination of types of connection: for example, a wireless Wi-Fi connection to a Wi-Fi hub, which is in turn in communication with the World Wide Web via a high-speed wired connection such as Ethernet. Such techniques are well known in the computing art.

Each subsystem of the invention is comprised of hardware and software elements which communicate with the other subsystems of the invention via said communication means 3 to provide the capability of consumer data collection, retention, organization, analysis, and generation and delivery of rewards and incentives to the consumer at a specific place of business.

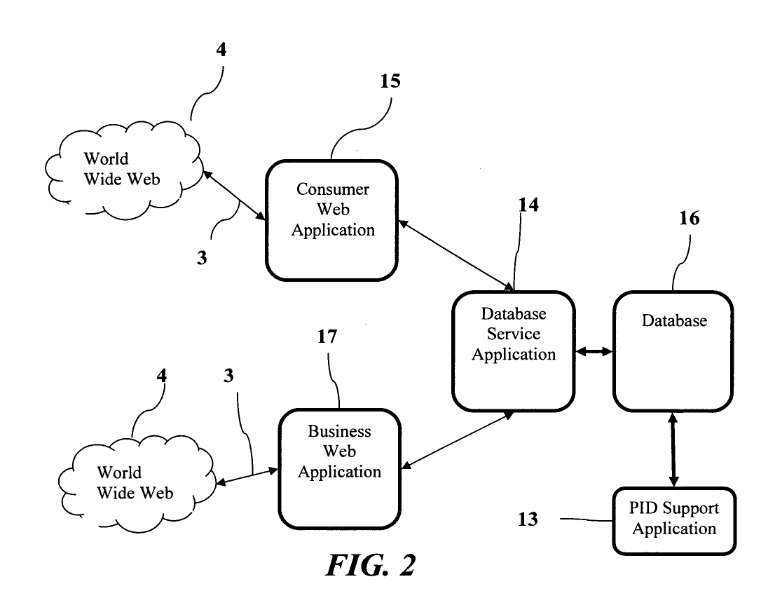

Referring to FIG. 2, the Central Subsystem 1 is comprised of the following software elements: a consumer web application 15 that in conjunction with database service application 14, facilitates consumer access to central database 16; a business web application 17 that in conjunction with database service application 14 facilitates business proprietor access to central database 16; a Central Subsystem central database 16 maintained by database service application 14, whereon consumer information and business information are stored; and a PID Support application 13 facilitating both the unique encoding of card-type PIDs and establishing a unique beaming application on PDA-type PIDs. The combination of software elements comprising the Central Subsystem 1 may reside on a single web server host computer or may be distributed across a plurality of web server host computers. The consumer web application 15 is preferably in communication with the consumer's personal computer via the World Wide Web 4 utilizing communication means 3. The business web application 17 is preferably in communication with the business server 24 of the Business Subsystem 2 via World Wide Web 4 utilizing communication means 3.

Consumer and business proprietor information are stored in the Central Subsystem central database 16. Preferably, consumer and business data are retained on the Central subsystem central database 16 in a secure manner by means such as password access, encryption, encoding, or the like. Furthermore, any internet transmission of said data utilizes World Wide Web transmission protocols and data encryption methods that are well known in the art. Any non-Internet communication may utilize encoding and encryption techniques which are well known in the art in order to protect transmitted data from interception and use by an unauthorized party. Firewall protection may further limit access to the Central Subsystem central database 16, allowing access through only specified ports. Additionally, employing user login and password requirements at specific ip addresses may be utilized to further enhance central database 16 security.

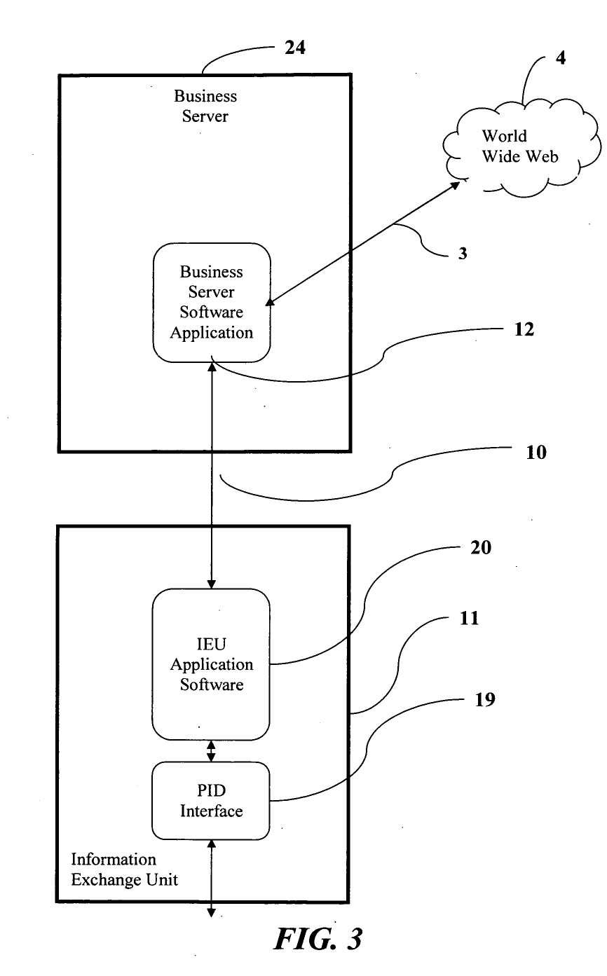

Referring to FIG. 3, Business Subsystem 2 comprises an Information Exchange Unit (IEU) 11 specific to the present invention and a business server 24 comprising a personal computer well known in the art with a business server software application 12 residing thereon for managing the business server 24. The Business Subsystem 2 is utilized by the business proprietor. Business Subsystem 2 enables the business to retrieve a unique personal identifier from the consumer's PID 7 during a visit transaction, via the PID Interface 19 of the IEU 11. If a business proprietor has configured a visit-based awards system, continued consumer visit transactions at the place of business (via interfacing with the IEU 11) can trigger a reward or incentive once the consumer has met or exceeded the visit-based award/incentive criteria. Also, Business Subsystem 2 enables the business to retrieve a unique personal identifier from the consumer's PID 7 during a purchase transaction at the POS of the participating business. If a business proprietor has configured a purchase-based awards system, continued consumer purchase transactions at the place of business (via PID interface at the POS) can trigger a reward or incentive once the consumer has met or exceeded the purchase-based award/incentive criteria.

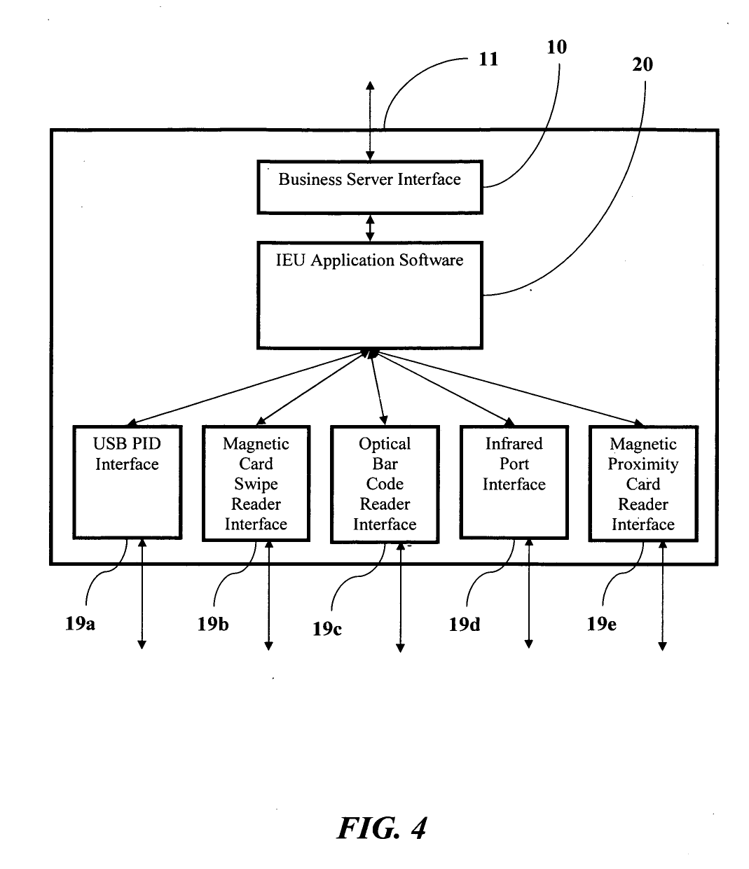

As depicted in FIG. 3 and FIG. 4, the IEU 11 of the Business Subsystem 2 comprises a basic computer having a microprocessor and memory, and having at least one business server interface 10 that may be selected from the group comprising a radio communications port of the type commonly used in personal computers such as that defined in Institute of Electrical and Electronic Engineers (IEEE) specification 802.11 commonly known as WiFi, an Ethernet interface port, a standard computer serial interface port, a standard computer parallel port, or a USB interface port. As depicted in FIG. 4, the IEU 11 is further comprised of one or more PID interfaces 19 that may be selected from the group consisting of a standard magnetic card reader 19b (i.e. swipe, dip or contact), a USB interface 19a, a radio communications port of the type commonly used in personal computers such as that commonly known as Bluetooth, an optical bar code reader 19c, a magnetic proximity reader interface 19e, a radio frequency tag communications interface, or an infrared communications port 19d. The IEU 11 is further comprised of IEU Application Software 20 specific to the present invention that is in communication with the PID interface 19 of the IEU 11 and with the business server interface 10 of the IEU 11. The IEU 11 may have any number of PID interfaces 19 of any of the types disclosed above, in any combination. The invention is not limited by the specific number or types of PID interfaces 19 included in the IEU 11. An example embodiment of the IEU 11 is shown in FIG. 4, in which the IEU 11 includes a USB PID interface 19a, a magnetic card swipe reader interface 19b, an optical bar code reader interface 19c, an infrared interface 19d, and a magnetic proximity card reader 19e. Further alternate embodiments of the IEU 11 may include additional PID interfaces 19 of any of the types described herein and their equivalents known within the art.

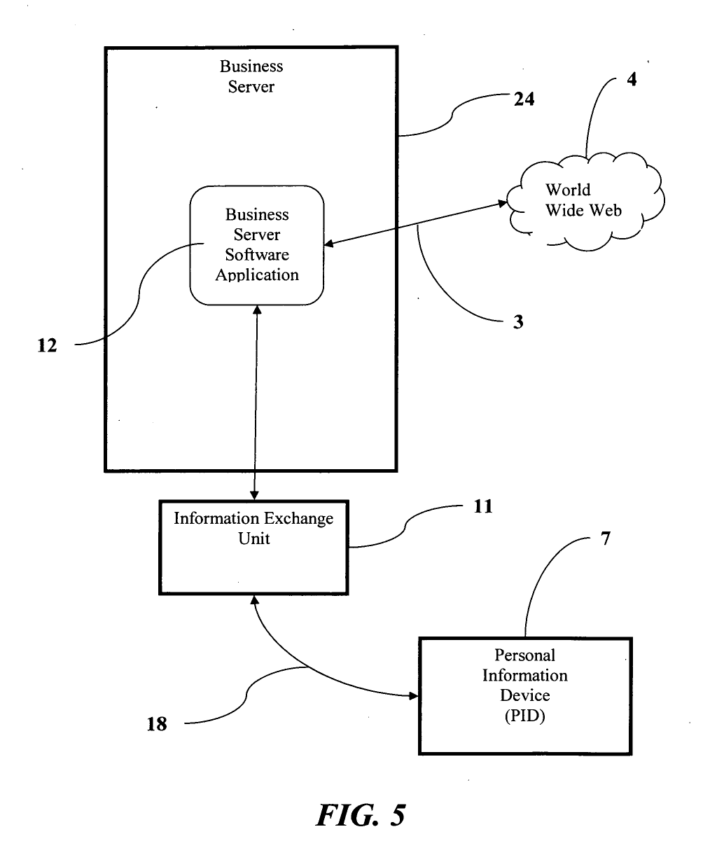

Depicted in FIG. 5, the PID 7 of the invention is a small, handheld device comprising a memory for storing information and a first communication means 18 that is complementary to and utilized for communicating with an IEU interface 19 of the IEU 11, as described above. First communication means 18 may be selected from the group consisting of magnetic card swiping, dipping or contacting; magnetic proximity card reading; optical bar code reading; serial data transmission; infrared data transmission; radio frequency data transmission; and radio frequency tag proximity communication. A PID 7 may take one of numerous forms selected from the group consisting of, but not limited to, a Personal Digital Assistant (PDA), which further comprises a consumer PDA mobile software application specific to the invention (the PDA mobile application software) and an infrared communications means; a PDA which further comprises a consumer PDA mobile software application specific to the invention (the PDA mobile application software) and a radio frequency communications means utilizing a standardized communication protocol and hardware layer which are well known in the art, for example Bluetooth™; a PDA cellular telephone, which further comprises a consumer PDA mobile software application specific to the invention (the PDA cell phone mobile application software) and an infrared communication means which is well known in the art; a portable solid state memory device commonly known as a USB thumb drive having a standard serial data bus communication means of the type known as a Universal Serial Bus (USB) interface, which is commonly used to store and carry data between computers; a Radio Frequency (RF) tag device well known in the art having an RF communications means; an optical bar coded card having an optical bar code communications means; a magnetic proximity card having a magnetic communications means known in the art; a magnetic swipe card having a magnetic swiping communication means known in the art that may be similar to standard magnetic credit cards that are well known in the art; a magnetic contact card having a magnetic contact communication means known in the art; and a magnetic dip card having a magnetic dip communication means known in the art. The PID 7 of the present invention typically remains in the possession of the consumer.

In use, the consumer carries the PID 7 upon his person, and when entering a participating business, the consumer communicates their PID 7 with the PID interface 19 of the IEU 11, preferably upon entry to the place of business. Communication between PID 7 and the IEU 11 occurs, transferring the consumer's unique personal identifier and logs the consumer's visit transaction with the Business Subsystem 2 for possible later uploading at a configurable interval as a transaction bundle communicated to the Central Subsystem central database 16 via communication from the business server 24 to the business web application 17 of the Central Subsystem 1, said communication taking place over the World Wide Web 4 by communication means 3. If the consumer is using a PID 7 having memory capability, such as a PDA embodiment having infrared communication capability or a USB thumb drive, the IEU 11 may also transmit information to the PID 7 embodiment as pre-determined by the business proprietor. Similarly when a consumer is making a purchase transaction at the POS of a participating place of business, the unique personal identifier on the consumer's PID 7 may be utilized by the business proprietor to log the consumer's purchase transaction data with the Business Subsystem 2 for possible later uploading at a configurable interval as a transaction bundle communicated to the Central Subsystem central database 16 via communication from the business server 24 to the business web application 17 of the Central Subsystem 1, said communication taking place over the World Wide Web 4 by communication means 3.

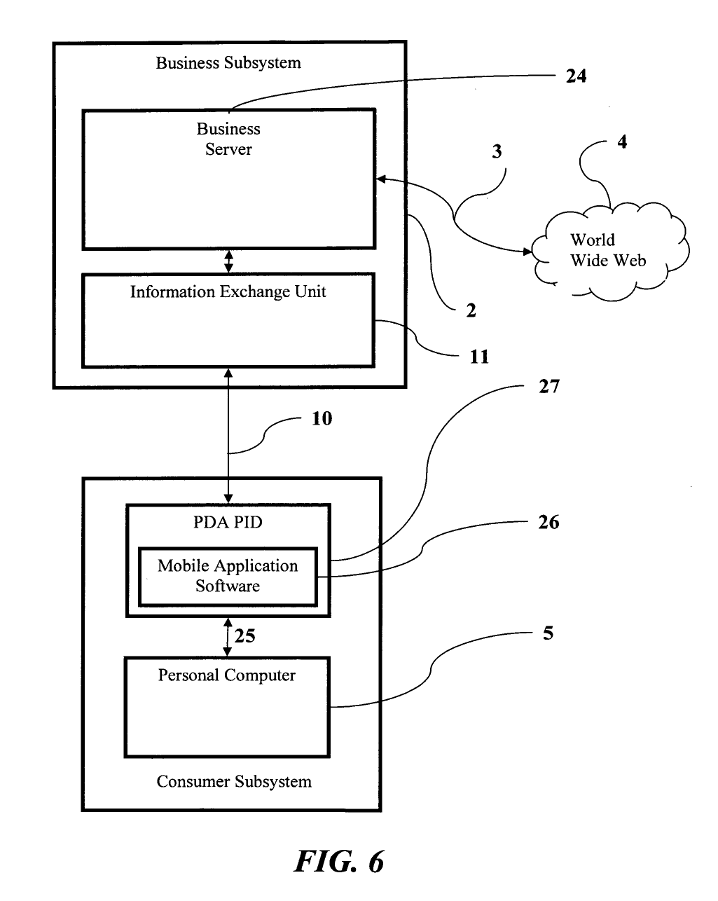

Referring to FIG. 6, a Personal Digital Assistant (PDA) embodiment of the PID (hereafter PDA PID 27), is comprised of a PDA, which is well known in the art, having Mobile Application Software 26 residing thereon which is specific to the invention. The Mobile Application Software 26 operates to store a consumer's unique personal identifier on the PDA PID 27, and also operates to manage communication between the PDA PID 27 and the IEU 11 of the Business Subsystem 2. The PDA PID 27 may be capable of communicating with the consumer's personal computer 5 utilizing a standard PDA interface means, typically used for synchronizing the PDA with the computer, which is well known in the art. Alternatively, the PDA PID 27 may be capable of communicating with the consumer's personal computer 5 utilizing a standard infrared interface, a standard computer serial data interface, or a standard radio frequency interface, for example the current industry standard Bluetooth™. Such PDA synchronization interfaces are well known in the art. The PDA PID 27 communicates with the IEU 11 using a business server interface 10 selected from the group comprising infrared data transmission and radio frequency data transmission, for instance, Bluetooth™.

In use, the consumer carries PDA PID 27 upon his person, and when entering a participating business, the consumer may initiate communication between their PDA PID 27 and IEU 11 at the PID Interface 19, by initiating either infrared or radio frequency data transmission from PDA PID 27. Communication between PDA PID 27 and IEU 11 occurs, allowing the Business Subsystem 2 to read the unique personal identifier from the PDA PID 27 and log the consumer's visitation transaction for possible later uploading at a configurable interval as a transaction bundle communicated to the Central Subsystem central database 16 via communication from the business server 24 to the business web application 17 of the Central Subsystem 1, said communication taking place over the World Wide Web 4 by communication means 3. The IEU 11 may also transmit information to PDA PID 27 as pre-determined by the business proprietor. Upon returning home from the place of business, the consumer may then synchronize PDA PID 27 with the consumer's personal computer 5, allowing the transfer of information received by and viewable on the PID 21 from the IEU 11 to the consumer's personal computer 5. Alternatively, the consumer may simply initiate infrared or radio frequency data transmission between PDA PID 27 and the consumer's personal computer to transfer the business information to the consumer's personal computer 5. Similarly when making a purchase transaction at a participating place of business, PDA PID 27 may communicate with Business Subsystem 2 at the POS and log the consumer's purchase transaction with the Business Subsystem 2 for possible later uploading at a configurable interval as a transaction bundle communicated to the Central Subsystem central database 16 via communication from the business server 24 to the business web application 17 of the Central Subsystem 1, said communication taking place over the World Wide Web 4 by communication means 3.

A preferred embodiment of the PDA PID 27 is one wherein the PDA is comprised of a standard infrared communications means for both receiving and transmitting information. Such PDA infrared interface ports are well known in the art.

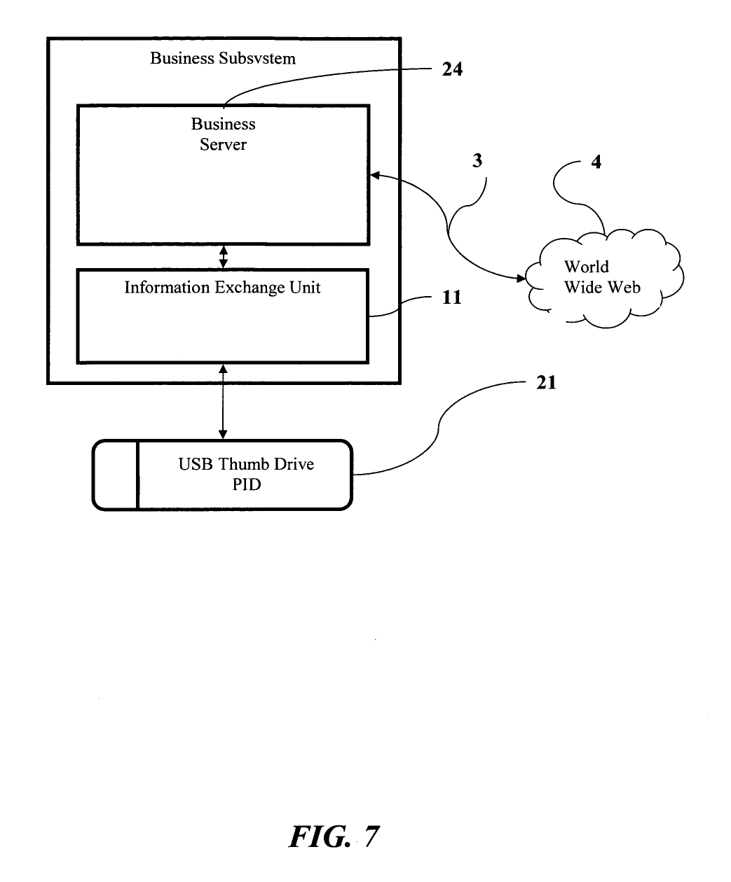

FIG. 7 depicts a solid state memory device PID 21 embodiment of the present invention, wherein the PID 21 is configured to be small, portable, transferable from computer to computer, and interfaces electronically with a standard personal computer interface such as the USB interface which is well known in the art. Such USB solid state memory devices are well known in the computing art and are commonly known as USB “thumb drives”. FIG. 7 depicts USB thumb drive PID 21 communicating with an IEU 11 of Business Subsystem 2.

When using the USB thumb drive embodiment 21 of the PID, the consumer must register with the system of the present invention to have a unique personal identifier assigned to them. Next, the consumer may use their personal computer 5 to communicate with the consumer web application 15 of the Central Subsystem 1 over the World Wide Web 4 by communication means 3. The consumer's unique personal identifier is communicated to the consumer's personal computer 5, and the consumer's personal computer 5 then writes the unique personal identifier to the memory of the USB PID 21 while the USB PID 21 remains inserted in the receiving USB port of the consumer's personal computer 5. The consumer then removes the USB PID 21 and carries it upon his person. Upon entry into a place of business that utilizes the consumer loyalty system of the invention, the consumer inserts the USB PID 21 into a USB receiving port of the IEU 11 of the Business Subsystem 2. Upon insertion of the USB PID 21, the IEU 11 reads the unique personal identifier and logs the consumer's visit transaction for possible later uploading at a configurable interval as a transaction bundle to the Central Subsystem central database 16 via communication from the business server 24 to the business web application 17 of the Central Subsystem 1, said communication taking place over the World Wide Web 4 by communication means 3. Similarly when making a purchase transaction at a participating place of business, PDA PID 21 may communicate with Business Subsystem 2 at the POS and log the consumer's purchase transaction and relevant data for possible later uploading at a configurable interval as a transaction bundle communicated to the Central Subsystem central database 16 via communication from the business server 24 to the business web application 17 of the Central Subsystem 1, said communication taking place over the World Wide Web 4 by communication means 3.

In all cases wherein the PID 7 is comprised of a read/write memory, for example a PDA PID 27 or a USB thumb drive PID 21, the consumer's application software residing on the consumer personal computer 5 reads files from, and may write files to, the PID 7 in accordance with a format specifically designed for the application of the present invention.

An embodiment of an RF tag PID 7 may have an RF tag that is adapted to be carried on a set of keys for ease of portability. Another alternate embodiment of the RF tag PID 7 may have an RF tag that is placed within a plastic card adapted to fit within the consumer's wallet. Other alternate embodiments exist which are equivalent in the art to the embodiments described herein and do not depart from the spirit or gist of the invention: such embodiments of the RF tag PID 7 are typified as being small, easy to carry, and are within the intended scope and breadth of the invention. In use, the consumer carries the RF tag PID 7 on his person, and upon entry of the place of business, the RF tag PID interface 19 of the IEU 11 recognizes the presence of the consumer's RF tag PID, reads the unique personal identifier from the consumer's RF tag PID, and logs the unique personal identifier and this consumer's visit transaction for possible later uploading at a configurable interval as a transaction bundle communicated to the Central Subsystem central database 16 via communication from the business server 24 to the business web application 17 of the Central Subsystem, said communication taking place over the World Wide Web 4 by communication means 3. Similarly when making a purchase transaction at a participating place of business, RF tag PID 7 may communicate with Business Subsystem 2 at the POS and log the consumer's purchase transaction for possible later uploading at a configurable interval as a transaction bundle communicated to the Central Subsystem central database 16 via communication from the business server 24 to the business web application 17 of the Central Subsystem 1, said communication taking place over the World Wide Web 4 by communication means 3.

PID 7 of the present invention stores only the consumer's unique personal identifier, while all of the consumer's personal information remains stored and secured on the central database of the Central Subsystem 1. In this manner, a consumer's personal information is not susceptible to theft or misappropriation since the PID 7 is merely conveying a pointer to consumer data on central database 16 of the Central Subsystem 1, in the form of the consumer's unique personal identifier.

The consumer utilizes the system by entering a participating place of business and presenting his PID 7 to the appropriate PID interface 19 of the IEU 11 or of the POS at that business. For instance, in the case wherein the consumer utilizes a PDA PID 27 having an infrared interface, the consumer points the PDA PID 27 infrared port at the infrared PID interface 19d of the IEU 11 and initiates communication. In the case where the consumer utilizes a PDA PID 27 with a radio frequency interface, the consumer presents the PDA PID 27 in proximity to the IEU 11 and initiates radio frequency communication. In the case where the consumer utilizes a solid state memory PID with a USB interface, also known as a thumb drive, the consumer inserts the thumb drive PID 21 into the USB PID Interface port 19a of the IEU 11. The IEU Application Software 20 recognizes the USB PID 21 and initiates communication. Likewise, in the case wherein the user utilizes a magnetic card PID, the consumer swipes, dips or contacts the magnetic card through or against the magnetic card reader PID interface (i.e. 19b and 19e) of the IEU 11. Upon swiping the card, the IEU application software 20 recognizes the unique personal identifier and accepts the unique personal identifier stored on the card and read by the card reader. In all cases, the IEU Application Software 20 receives the unique personal identifier from the PID 7, checks to verify that the unique personal identifier is in the correct format of the system, reads the unique personal identifier, stores the unique personal identifier, and communicates the unique personal identifier to the business server 24 as a consumer visit transaction. The IEU Application Software 20 checks the unique personal identifier format and only identifiers of the correct format will elicit a response from the IEU 11. If the data is invalid, the IEU 11 will report an error and no consumer visit transaction will be logged. With a successful read of a consumer's unique personal identifier, the IEU 11 communicates the unique personal identifier to the business server 24 utilizing the communication means of the business server interface 10 that is shown in FIG. 3 and FIG. 4, which may be a hardwire standard electrical interface such as Ethernet, a standard serial computer interface, a USB interface, a wireless interface such as the standard known as WiFi, or a standard computer parallel interface; or the unique personal identifier may be communicated by storing on portable media such as a USB thumb drive, floppy disk, or optical disk, which is then physically carried to the business server 24 where it is read by the appropriate media interface port. In the case where the unique personal identifier is stored on portable media, the business server 24 may be located anywhere at all, for instance at the proprietor's remote office or home. In this manner the IEU 11 may be the only hardware element of the system to reside at the physical place of business if only logging of consumer visit transactions is desired.

The use, as described above, for logging consumer visit transactions is similar to use of the present invention in logging consumer purchase transactions as well. Instead of the PID to Business Subsystem 2 interface occurring at the IEU 11, as with visit transactions, the PID to Business Subsystem 2 interface occurs at the POS when logging a consumer purchase transaction. Different information regarding the consumer's visit transaction or purchase transactions may be logged. Visit transactions may simply log the time and date of a consumer's visit transaction at the place of business, while purchase transactions may log the time and date of purchase, number of purchases, volume of purchases, and the like. In this manner, the system and method of the present invention allows business proprietors to collect consumer data regarding store visits when purchases were made as well as when purchases were not made.

Prior to utilizing the system, a PID 7 must be loaded with a unique personal identifier specific to a particular consumer who will be a user of the system. The consumer's personal information communicated to the central database 16 of the Central Subsystem 1 is linked with a unique personal identifier in one of a variety of methods. The consumer may utilize his personal computer to communicate with the consumer web application 15 of the Central Subsystem 1 over the World Wide Web 4 via communication means 3, and may provide personal information including but not limited to geographic, demographic, financial, contact, household, name, address, telephone number, email address, age, gender, household income, number of persons in the household, product preferences, store and merchant preferences, amount spent on various categories of goods and services, and other information related to the personal spending habits of the consumer to the consumer web application 15 for processing. Alternatively while at a place of business, the consumer may fill out a paper form that may have a removable card attached having a unique personal identifier thereon (i.e. identifier printed on card and also stored within card's magnetic strip). After the consumer provides their personal information and is issued their unique personal identifier, the business proprietor, one of his employees, or the consumers themselves, may then (or at a later time) enter the consumer's information on a computer communicating with the consumer web application 15 via the World Wide Web 4. A yet further alternative method for providing the consumer personal information to the consumer web application 15 is the filling out of a paper form by the consumer and mailing the form to a receiving entity who provides the consumer personal information to the consumer web application 15 by entering said consumer information on a computer communicating with the consumer web application 15 via the World Wide Web 4. Such alternate methods may be beneficial for those consumers who wish to participate in the consumer loyalty system of the invention, but who do not own a personal computer, or who are not skilled at using a personal computer. The personal information provided by the consumer may consist of a subset of the above identified types of information, and additional information may be provided by the consumer. Once a consumer's personal information is loaded into the system, the database service application 14 processes and stores the data on the central database 16 of the Central Subsystem 1 for later retrieval and use by the merchant. The consumer personal information stored on the central database 16 of the Central Subsystem 1 may also later be retrieved and modified by the consumers. This is helpful, for instance, when a consumer changes their address or name, or some other field of information requiring an update by the consumer.

Next a PID 7 is initialized for use by the consumer. This step is comprised of providing an alphanumeric unique personal identifier to a consumer. A preferred method, as described above, entails a consumer completing an information form at a participating place of business and immediately being issued a card bearing the unique personal identifier (i.e. identifier printed on card and also stored within card's magnetic strip) that will later be electronically linked to the consumer's provided information when it is later inputted into the central database 16 of the Central Subsystem 1. The issued unique personal identifier card may also provide direct communication capabilities with an IEU 11 via means described herein (i.e. a magnetic or optically readable unique personal identifier card). Additionally, once the consumer has been assigned a unique personal identifier, as above, the consumer may obtain the capability to utilize a PDA as their PID 7 embodiment. In the case where the consumer desires a PDA PID 27, the PID support application 13 generates a file containing the unique personal identifier for download to the PDA PID 27 and communicates the file to the consumer's personal computer 5 for delivery to the PDA PID 27 upon the next synchronization of the PDA PID 27. In the case were the PID 7 is a magnetic card and may not be immediately available to the consumer at the place of business, the PID support application 13 communicates the unique personal identifier to a magnetic card writer that is well known in the art. The unique personal identifier is then written to a magnetic card which is delivered to the consumer for use by any standard means for delivery of mail which are well known. In the case where the PID 7 is a radio frequency tag, the PID support application 13 may communicate the unique personal identifier to a radio frequency tag writer which writes the unique personal identifier to a radio frequency tag utilizing equipment and techniques well known in the art, and the tag is delivered to consumer for use by any standard means for delivery of mail which are well known. In the case where the PID is a solid state memory device such as USB thumb drive, the unique personal identifier is communicated by the PID support application 13 or the consumer web application 15 of the Central Subsystem 1 to the consumer's personal computer via the World Wide Web 4 utilizing communication means 3 which is well known in the art. The consumer's personal computer may then write the unique personal identifier to the memory of the USB PID 21 via a USB port of the consumer's personal computer utilizing standard techniques for writing files to a memory device. The writing of a unique personal identifier to a USB PID 21 may also occur at a proprietor's place of business. In the case wherein the PID is an optical bar code, the optical bar code is printed onto a sticker or card which is then sent to the consumer. PID 7 embodiments, such as magnetic cards, optical cards or thumb drives, may be immediately available to the consumer during their registration at the place of business, or such PID 7 embodiments may be processed and soon thereafter delivered to the registered consumer.

The above embodiments of the present invention overcome the difficulty encountered by some business proprietors who do not have a computer on the business premises that can operate as a business server 24, or who wish to place the IEU 11 remotely from the business server 24 due to the nature or physical setup of their business operation. This may be desirable, for instance, for businesses whose immediate physical environment may not be suitable for the placement of personal computers. One example of such a business is a car wash. IEU 11 also communicates business information to the PID 7 in those circumstances wherein the PID is of the type that can receive and store such information, such as the PDA PID 27 and the USB thumb drive PID 21.

Alternatively, some consumers may not own or may not know how to use a personal computer. The above embodiments of the present inventive system involving paper mail registration and business proprietor assisted registration allow the consumer information to be entered into the system by either the business proprietor or some other person manually keyboarding the information into a computer that is in communication with the Central Subsystem 1 via the World Wide Web 4.

Once the consumer has registered with the system as described above, the consumer's personal information has been loaded into the Central Subsystem central database 16, and the unique personal identifier provided on a PID 7 (i.e. card-type) or has been generated and loaded into a PID 7 (i.e. PDA-type), the consumer is able to enter a place of business and utilize the system of the invention. Upon entry to a merchant's place of business, the consumer presents the PID 7 to the IEU 11 of the Business Subsystem 2 by the appropriate method dependent upon the type of PID 7 used by the consumer to log a visit transaction. For example, in the case of the PDA PID 27 having an infrared port, the consumer points the PDA at the infrared interface 30 of the IEU 11 and initiates communication between the PDA PID 27 and the IEU 11. For the case where the PID 7 is a magnetic card, the user swipes, dips, or contacts the card through or against the magnetic card reader interface (19b and 19e) of the IEU 11. In the case where the PID 7 is a PDA having a radio frequency interface such as Bluetooth™, the user initiates Bluetooth™ communication between the PDA PID 27 and the IEU 11 utilizing the appropriate commands of the PDA. In the case where the PID 7 is a radio frequency tag, the consumer simply presents the tag in proximity to the tag reader of the IEU 11. In the case where the PID 7 is a solid state memory device such as a USB thumb drive, the consumer inserts the memory device PID 21 into the interface designed to receive it, for instance a USB port 19a, on the IEU 11 of the Business Subsystem 2. The IEU 11 then reads the unique personal identifier stored on the PID 7, and presents the unique personal identifier to the IEU application software 20 for processing and logging of the consumer visit transaction. In all these cases, the IEU application software 20 checks the data format of the unique personal identifier and only a unique personal identifier of the correct form will elicit a response from the IEU 11. If the data is invalid, then the IEU 11 will report an error and no business information is provided to the consumer and a visit transaction is not logged onto Central Subsystem 1. Once the unique personal identifier is validated, it is communicated to the business server 24 by the IEU application software 20 through the business server interface 10 and a consumer visit transaction is logged for possible later uploading at a configurable interval as a transaction bundle communicated to the Central Subsystem central database 16 via communication from the business server 24 to the business web application 17 of the Central Subsystem 1, said communication taking place over the World Wide Web 4 by communication means 3.

Again the use, as described above, for logging consumer visit transactions is similar to use of the present invention in logging consumer purchase transactions as well. Instead of the PID to Business Subsystem 2 interface occurring at the IEU 11, as with visit transactions, the PID to Business Subsystem 2 interface occurs at the POS when logging a consumer purchase transaction.

The Business Subsystem 2 may communicate business-specific information to the consumer. This is accomplished by various means depending upon the type of PID 7 utilized by the consumer. For consumers utilizing a PDA PID 27 or USB thumb drive PID 21, the business-specific information may be written to the memory of the PID utilizing the communication means particular to the specific PID. For instance, a consumer utilizing a PDA PID 27 with an infrared communication interface will receive business-specific information transmitted from the IEU 11 of the Business Subsystem 2 via infrared port interface 19d. Consumers utilizing a PDA PID 27 having an RF interface such as Bluetooth will receive business-specific information via an RF interface. Consumers utilizing a USB thumb drive PID 21 will receive business-specific information via the USB PID Interface 19a of the IEU 11. Consumers utilizing optical bar code, magnetic swipe, magnetic proximity, or other PID types without the ability to receive data from the IEU 11 may receive business information via email or via consumer notification while accessing the consumer web application 15 of the Central Subsystem 1 through the World Wide Web 4.

After the consumer has visited the place of business, the Business Subsystem 2 communicates the unique personal identifier, along with other information relative to the consumer's transaction at the place of business, such as amount of purchase, date of visit, time of visit, and other consumer-specific information, to the Central Subsystem 1 via the World Wide Web 4 by communicating with the business web application 17 of the Central Subsystem 1. The Central Subsystem central database 16 is updated with the information provided by the Business Subsystem 2. The consumer may then utilize his personal computer 5, or any personal computer with an internet connection to the World Wide Web 4, to communicate with the consumer web application 15 of the Central Subsystem 1. Upon entry of a username and password, the consumer may present a request to view his personal information, transaction history, progress towards rewards, and other consumer-specific information. The request is entered by the consumer's interaction with a windows-based web page generated by the consumer web application 15. Such a web page includes the capability of a consumer entering information by keyboard typing and/or selecting options by clicking buttons of a computer mouse, all well known in the computing art. The web page is specific to a consumer and may be protected by the use of a username and password specific to that consumer. The consumer may access the web page via the World Wide Web 4 from any computer, type in his specific username and password, and view his specific data which may include participating business address information, reward status, indicators displaying how close the consumer is to achieving a reward or incentive status, history of purchases made, notification of earned rewards, and the like. The information displayed to the consumer in this manner is not limited to the afore-mentioned information. Furthermore, the method chosen to communicate with the consumer may be redundant; for instance, a consumer utilizing a PID 7 with memory capability may receive business information from the IEU 11 at the time of visiting the place of business as indicated above, and the business information on the central database 16 of the Central Subsystem 1 may also be displayed on the web page which is personal to the consumer as mentioned above. A further additional means of communicating business information to the consumer is for the Central Subsystem 1 to implement a web-based message system such that a consumer is assigned a web-based page managed by the consumer web application 15. For this case, the consumer may access his specific web-based message system page via the World Wide Web 4 after entering their username and password. In such a manner, the consumer may be able to view messages generated by the system providing information such as progress towards rewards, promotional messages, messages expressing appreciation for using the system of the invention or visiting a particular place of business, and the like.

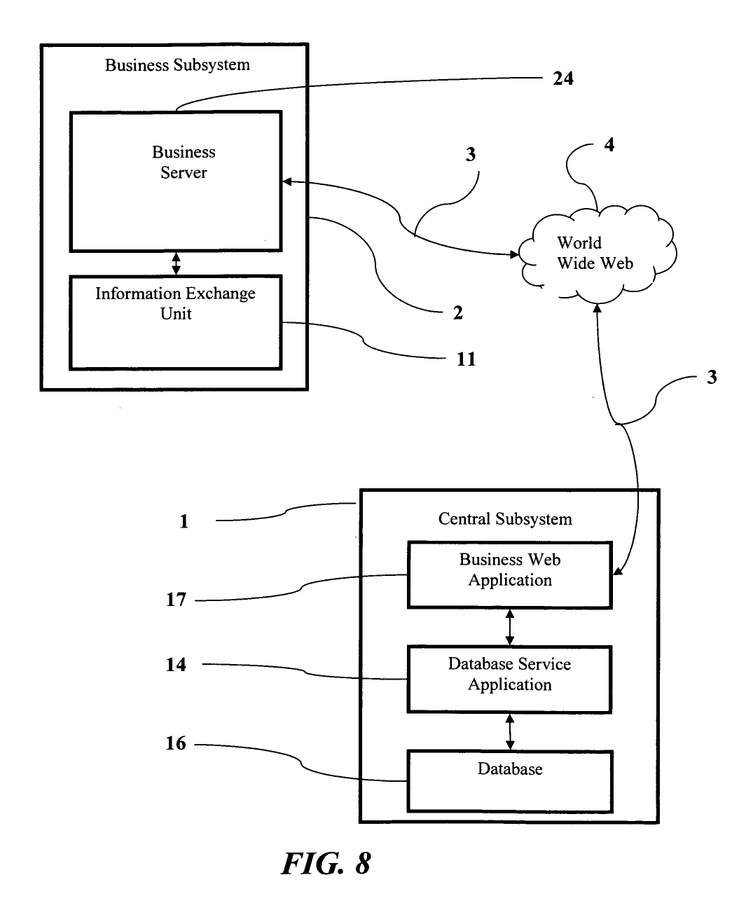

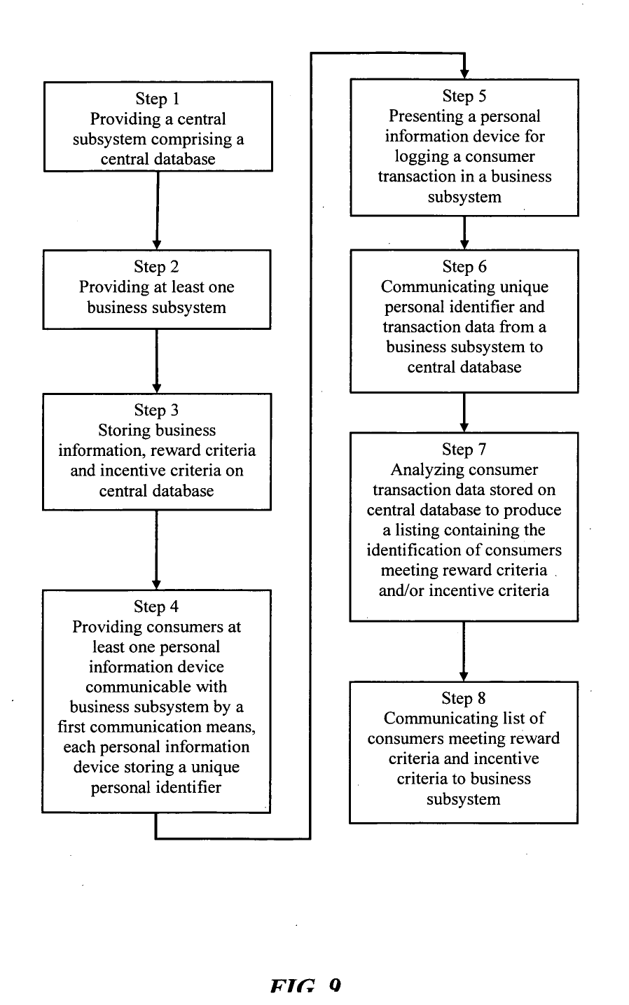

When consumer and transaction information have been transmitted to the Central Subsystem central database 16 as described above, the business proprietor may access the consumer data stored in the Central Subsystem central database 16 for the purpose of review and analysis in a variety of ways useful to the business proprietor. The business proprietor may access the consumer information by communication between the business server 24 and the business web application 17 of the Central Subsystem 1 as depicted in FIG. 8. The business proprietor can select criteria for incentives attainable to his consumers by selecting from options provided to him through the business web application 15 of the Central Subsystem 1. The business proprietor, after establishing their rewards program during their initial registration process, may later modify the rewards program via communication with and assistance from the support staff for the system of the present invention, however, a business proprietor is capable of self-modifying their incentive program via interfacing with the business web application 17. The business proprietor may also utilize the information stored in the Central System central database 16 in order to gain an understanding of the demographic, geographic, and other attributes of his consumers. In this manner shopping habits, demographic and geographic analysis, amount of purchases made by grouping of consumers, and other data analysis may be performed by the business proprietor. When the system is being established, the business proprietor may select rewards criteria for consumers based upon parameters specific to his business: for instance, the business proprietor may choose to reward consumers based upon the number of visits to the place of business, the number of purchases made, or the consumer's purchase volume. Anytime after registration, a business proprietor may create or modify an already existing incentive program, which may be based upon any metric or set of metrics from consumer information stored in the central database 16 (i.e. consumer's birth day). The invention is not limited by the number of specific metrics or types of information the business proprietor chooses to collect, nor is the invention limited by a specific number or types of information utilized by the business proprietor to determine consumer rewards or incentives. It is a feature of the invention that each business proprietor selects the information he collects, and each proprietor selects the specific award criteria relative to his specific business. The flexibility of the invention which allows each business proprietor to tailor the use of the invention to his specific business operation is a significant advancement over the state of the art.

In a preferred embodiment of the invention all information transmitted via the World Wide Web 4 is communicated utilizing standard well-known techniques for transmitting data in a secure fashion over the World Wide Web, such as the https protocol which is well known in the art.

Consumer reward information is stored in the Central Subsystem central database 16. Rewards may be delivered to the consumer during their visit to the place of business in the following manner: first, the consumer may view the status of any rewards earned by accessing the consumer web application 15 from a personal computer 5. The consumer enters his username and password, and his reward status may be displayed on his consumer-specific web page. Once a reward is earned, the Central Subsystem business web application 17 transmits the reward to the particular business server 24. The consumer web application 15 may also transmit an email to the consumer indicating that an award has been earned and is waiting for him at a particular place of business, also the Central System consumer web application 15 may send a consumer notification via the web-based message system of the present invention. Next, the consumer visits the place of business to make a purchase. Upon checkout through a POS terminal, the consumer is rewarded with a discount off the purchase price, free merchandise, or the like, that has been stored on the business server 24.

It can thus be seen that the system of the invention provides for the rewarding of consumer loyalty without the use of paper coupons, letters, tickets or the like. The ease of use of the system in providing for the automatic issuance of rewards and incentives, award and incentive notification to the consumer, elimination of paperwork, and use of the World Wide Web allowing the consumer to review lists of businesses participating in the invention and to review the status of their personal awards are features of the invention that are significant advancements in the state of the art.

At any time the consumer may access the Central System consumer web application 15 via the World Wide Web 4 by utilizing any personal computer 5 with an Internet connection. The consumer may wish to do this in order to update his personal information in the system. Additionally, the consumer may also wish to enter quality survey information into the central database 16 in order to provide feedback regarding the merchant's performance, quality of goods and services, and the like for a specific business proprietor. The business proprietor is able to access consumer feedback information by communicating with the Central Subsystem business web application 17 to query the central database 16 of the Central Subsystem 1 for consumer feedback information relative to his business operation. In this manner the business proprietor is able to gain an understanding as to how the quality of his business operations is viewed by his consumers.

An alternate embodiment of the system of the invention is one wherein at least one question may be asked of the consumer when the consumer has accessed the consumer web application 15 of the Central Subsystem 1, and business proprietors may ask their registered consumer population to answer industry-specific surveys.

The disadvantages of the prior art are overcome by the various embodiments of the present invention. By allowing only a consumer's unique personal identifier to be transmitted to the IEU 11 upon entry to the place of business, the invention allows a consumer visit to be recorded even though no purchase has been made; the information is easily, quickly and securely exchanged; the consumer may be provided information about the business; and the merchant is provided an accurate set of data from which he can better analyze the shopping habits of his consumers, without the need for an actual purchase by the consumer.

Business proprietors may realize benefits such as reduced advertising costs and the ability to reach a wider target market than normally possible with the limited advertising budgets typically found in small to medium-size businesses. Furthermore, since the consumer loyalty and reward program is configurable by each business proprietor, the system of the invention is usable for a small to medium-sized business that does not have the assets, resources, or time to develop their own reward/incentive system. The system of the present invention is therefore usable by and beneficial to such businesses. The system of the present invention also provides an advantage to the business proprietor in that while the reward system is in use, the business proprietor has the ability to analyze consumer visit transactions, purchase transactions and consumer personal information stored on Central Subsystem central database 16, enabling the business owner to develop a better view of the demographic, geographic, and other metric information related to his particular consumer and market base. Such information is valuable for aiding in decision making; for instance, where, when, and how to spend advertising funds. These decisions can be critical for the success of such small to medium-sized businesses. A business proprietor who subscribes to the system of the present invention is therefore at an advantage over his competitors who do not utilize the system of the present invention.

Another aspect and advantage of the system is that the consumer is able to deliver quality survey and report information via the World Wide Web to the Central Subsystem 1 for processing, analysis, and storage on the Central Subsystem central database 16. This quality survey information is stored in the central database 16 and may be used by the business proprietor to gain a better understanding of the way his consumers view his business operation.

Another aspect and advantage of the invention is that a consumer is enabled to review a directory of places of business participating in the system of the invention in a given geographic area. The consumer accesses this data via the World Wide Web 4 by his personal computer 5 to access the Central Subsystem 1 consumer web application 15, which communicates with the Central Subsystem central database 16 and provides a response to the consumer's query indicating businesses participating in the system of the present invention that meet a certain criteria, such as geographic location or price criteria. The consumer is thus able to review a list of desirable participating businesses. The system of the invention is therefore useful to encourage patronage of participating businesses.

Another aspect and advantage of the invention is that it is easily utilized to provide a wide range of reports based upon demographic, shopping pattern, shopping habit, geographic, and other data, thus enabling the merchant to fine-tune his business operations to be better tailored to his target patrons. The system may support both “hard” rewards (for example, discounts and the like) and “soft” rewards (for example, preferred seating and the like). The system also builds consumer loyalty through the accumulation of consumer rewards, the value of which may increase as the consumer continues to spend more time and money at a particular business.

While specific embodiments of the invention are described herein, it is immediately obvious to one skilled in the art that equivalent embodiments are conceivable without departing from the gist and spirit of the invention.

1. A system for rewarding consumer loyalty and providing business information to consumers, comprising:
a central subsystem in communication with the World Wide Web comprising,
a central database containing business information and consumer information;
a database service application in communication with said central database for managing said central database;
a consumer web application in communication with said database service application for allowing said consumer access to said central database; and
a business web application in communication with said database service application for allowing a participating business access to said central database;
at least one business subsystem in communication with the World Wide Web comprising,
a business server containing a business server software application in communication with said central database via said database service application and said business server software application capable of storing a registered consumer's transaction data, wherein said transaction data may be periodically communicated to said central database via said database service application; and
an information exchange unit in communication with said business server by a business server interface; and
a personal information device capable of communicating with said information exchange unit by a first communication means, wherein said personal information device contains only a unique personal identifier that is communicated to said information exchange unit.

2. The system for rewarding consumer loyalty and providing business information to consumers of claim 1, wherein said business server interface is selected from the group consisting of a serial computer interface, a parallel computer interface, a Universal Serial Bus computer interface, a radio frequency computer interface, removable portable magnetic media, removable portable solid state memory media, and a Universal Serial Bus removable portable thumb drive.

3. The system for rewarding consumer loyalty and providing business information to consumers of claim 2, wherein said first communication means may be selected from the group consisting of magnetic card swiping, dipping or contacting; magnetic proximity card reading; optical bar code reading; serial data transmission; infrared data transmission; radio frequency data transmission; and radio frequency tag proximity communication.

4. The system for rewarding consumer loyalty and providing business information to consumers of claim 3, wherein said personal information device may be selected from the group consisting of a personal digital assistant; a magnetic card; a proximity magnetic card; a solid state memory device having a universal serial bus serial data interface; radio frequency tag; and an optical bar coded card.

5. The system for rewarding consumer loyalty and providing business information to consumers of claim 4, wherein said consumer logs a visit transaction via communicating transaction data and said unique personal identifier stored on said personal information device with said information exchange unit by said first communication means, and wherein said information exchange unit communicates said unique personal identifier to said business server software application, and wherein said business server software application communicates said unique personal identifier to said central database via said database service application.

6. The system for rewarding consumer loyalty and providing business information to consumers of claim 5, wherein said consumer logs a purchase transaction via communicating transaction data and said unique personal identifier stored on said personal information device with said business server software application at a point of sale, and wherein said business server software application communicates said unique personal identifier to said central database via said database service application.

7. A method for rewarding consumer loyalty and providing business information to consumers, comprising the steps of:
providing a central subsystem in communication with the World Wide Web, said central subsystem comprising a central database;
providing at least one business subsystem in communication with the World Wide Web;
storing business information desired to be presented to said consumer, consumer reward criteria and consumer incentive criteria on said central database;
providing to said consumers at least one personal information device communicable with said business subsystem by a first communication means, each of said at least one personal information devices storing a unique personal identifier;
presenting said at least one personal information device at a place of business for logging a consumer transaction in said business subsystem;
communicating said unique personal identifier and transaction data from said business subsystem to said central database of said central subsystem;
analyzing said consumer transaction data stored on said central database to produce a listing containing the identification of consumers meeting said reward criteria and said incentive criteria; and
communicating said list of consumers meeting said reward criteria and said incentive criteria to said business subsystem.

8. The method for rewarding consumer loyalty and providing business information to consumers of claim 7, wherein said at least one personal information device is selected from the group consisting of:
a personal digital assistant having an infrared interface, wherein said first communication means is infrared data transmission;
a personal digital assistant having a radio frequency interface, wherein said first communication means is radio frequency data transmission;
a magnetic card, wherein said first communication means is magnetic card swiping or dipping;
a solid state memory device having a universal serial bus serial data interface, wherein said first communication means is serial data transmission;
a radio frequency tag, and wherein said first communication means is radio frequency tag proximity communications;
an optical bar coded card, wherein said first communication means is optical bar code reading; and
a magnetic proximity card, wherein said first communication means is magnetic proximity card reading.

9. The method for rewarding consumer loyalty and providing business information to consumers of claim 8, wherein said consumer transaction is a visit transaction, and said presenting said personal information device at a place of business originates at an information exchange unit.

10. The method for rewarding consumer loyalty and providing business information to consumers of claim 8, wherein said consumer transaction is a purchase transaction, and said presenting said personal information device at a place of business originates at a point of sale terminal.

11. A method for rewarding consumer loyalty and providing business information to consumers, comprising the steps of:
providing a central subsystem in communication with the World Wide Web, said central subsystem comprising a central database in communication with and managed by a database service application, a business web application in communication with said database service application for allowing a participating business access to said central database, and a consumer web application in communication with said database service application for allowing said consumer access to said central database;
providing at least one business subsystem in communication with the World Wide Web, said business subsystem comprising a business server containing a business server software application in communication with said central database via said database service application and said business server software application capable of storing consumer transaction data, and an information exchange unit in communication with said business server by a business server interface;
storing business information desired to be presented to said consumer, consumer reward criteria and consumer incentive criteria on said central database;
providing to said consumers at least one personal information device communicable with said information exchange unit by a first communication means, each of said at least one personal information devices storing a unique personal identifier;
presenting said personal information device at a place of business of a participating business for logging a consumer transaction;
communicating said unique personal identifier and transaction data to said business server software application on said business server;
communicating said unique personal identifier and transaction data from said business server to said central database of said central subsystem;
analyzing said consumer transaction data stored on said central database to produce a listing containing the identification of consumers meeting said reward criteria and said incentive criteria; and
communicating said list of consumers meeting said reward criteria and said incentive criteria to said participating business.

12. The method for rewarding consumer loyalty and providing business information to consumers of claim 11, wherein said personal information device is selected from the group consisting of:
a personal digital assistant having an infrared interface, wherein said first communication means is infrared data transmission;
a personal digital assistant having a radio frequency interface, wherein said first communication means is radio frequency data transmission;
a magnetic card, wherein said first communication means is magnetic card swiping or dipping;
a solid state memory device having a universal serial bus serial data interface, wherein said first communication means is serial data transmission;
a radio frequency tag, and wherein said first communication means is radio frequency tag proximity communications;
an optical bar coded card, wherein said first communication means is optical bar code reading; and
a magnetic proximity card, wherein said first communication means is magnetic proximity card reading.

13. The method for rewarding consumer loyalty and providing business information to consumers of claim 12, wherein said unique personal identifier is a 16 digit number.

14. The method for rewarding consumer loyalty and providing business information to consumers of claim 13, wherein said consumer transaction is a visit transaction, and said presenting said personal information device at a place of business originates at said information exchange unit.

15. The method for rewarding consumer loyalty and providing business information to consumers of claim 13, wherein said consumer transaction is a purchase transaction, and said presenting said personal information device at a place of business originates at a point of sale terminal.

16. The method for rewarding consumer loyalty and providing business information to consumers of claim 13, further comprising the step of, transmitting a consumer reward/incentive notification to consumers meeting said award criteria or said incentive criteria.

17. The method for rewarding consumer loyalty and providing business information to consumers of claim 16, wherein said transmitting a consumer reward/incentive notification occurs at said point of sale terminal at said participating business.

18. The method for rewarding consumer loyalty and providing business information to consumers of claim 16, wherein said transmitting a consumer reward/incentive notification occurs via a specific consumer email address.

19. The method for rewarding consumer loyalty and providing business information to consumers of claim 16, wherein said transmitting a consumer reward/incentive notification occurs within said central subsystem.

20. The method for rewarding consumer loyalty and providing business information to consumers of claim 19, wherein said transmitting a consumer reward/incentive notification within said central subsystem occurs on a consumer specific web-based message system.
